(19) United States
(12) Patent Application Publication
(10) Pub. No.: US 2004/0226348 A1
(43) Pub. Date: Nov. 18, 2004

(54) Magnetic assisted detection of magnetic beads using optical disc drives

(76) Inventors: Phillip Bruce III, San Diego, CA (US); James Rodney Norton, Santa ana, CA (US); Glenn Sasaki, El Cajon, CA (US); Mark Oscar Worthington, Irvine, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/205,005

(22) Filed: Jul. 24, 2002

Related U.S. Application Data
(60) Provisional application No. 60/307,486, filed on Jul. 24, 2001.

(51) Int. Cl. G01N 11/00

(52) U.S. Cl. 73/53.01

(57) ABSTRACT

The present invention is a method and apparatus for precise control of magnetic beads in an optical bio-disc. Embodiments of the present invention use electromagnets for precise control of the forces experienced by the magnetic beads. The use of electromagnets eliminates the need to design precise flow control mechanisms to keep beads in place. This is critical in the stage of washing in an assay, where beads attached to a bottom testing surface are separated from beads that are unattached. One embodiment contains a top electromagnet in a top layer of a bio-disc and a bottom electromagnet in a bottom layer of the bio-disc. Another embodiment is an apparatus of electromagnets that can be used to control the magnetic beads within the optical bio-disc. By adjusting the current flow to the electromagnets, precise control of beads can be accomplished.

### CROSS-REFERENCE TO RELATED APPLICATIONS

The present application claims the benefit of priority from U.S. Provisional Patent Application Ser. No. 60/307,486 filed on Jul. 24, 2001 and is hereby incorporated by reference.

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND OF THE INVENTION

1. Field of the Invention

This invention relates to using optical disc for performing assays, and in particular the invention is directed to precise control of magnetic beads during performing of such assays. More specifically, but without restriction to the particular embodiments hereinafter described in accordance with the best mode of practice, this invention relates to methods and apparatus for controlling magnetic bead movement and bonding in an optical disc.

2. Discussion of the Related Art

Beads are common devices used for many types of assays including immunoassays. One of the more common usage of beads involves attach probe molecules to beads to capture intended assay targets. For example, probe molecules are attached to beads to capture white blood cells to isolate them from blood samples.

Often in many bead applications, the washing and centrifugation of the assay sample can rip away beads from the detection surface. A major concern with the bead assay is the amount of force that a few covalent bonds has to hold a bead to the detection surface. Sometimes the assay area has a very shallow liquid depth (˜20-50 microns), the amount of capillary force that is required to move liquids through this area is quite high. In order to keep liquid flow at a low enough level so that attached beads are not stripped off, precise control of the forces is needed in moving the liquids.

Some mechanisms for control liquid flow include controlling centrifugal force and the use of capillary valves. By controlling the taper of the capillary valve, the flow may be controlled. However, there are many variables that can place high demand in the design of capillary valves and other flow control mechanisms. For example, the mass of the beads and the density of the assay solution can dictate the forces needed to keep the beads attached. Thus it is difficult to design valves and flow control mechanisms that will work with the wide variety of assay solutions and magnetic beads.

### SUMMARY OF THE INVENTION

The present invention is a method and apparatus for precise control of magnetic beads in an optical bio-disc. Embodiments of the present invention use electromagnets for precise control of the forces experienced by the magnetic beads. The use of electromagnets eliminates the need to design precise flow control mechanisms to keep beads in place.

One embodiment of the present invention is employed in an optical bio-disc, which is a modified optical disc similar to CD, CD-R, CD-RW, DVD or equivalents widely available in the market today. An optical bio-disc contains fluidic flow chamber on the disc surface for housing assay solution and magnetic beads. A bio-disc drive assembly is employed to rotate the disc, read and process any encoded information stored on the disc, and analyze the cell capture zones in the flow chamber of the bio-disc. The bio-disc drive is provided with a motor for rotating the bio-disc, a controller for controlling the rate of rotation of the disc, a processor for processing return signals from the disc, and analyzer for analyzing the processed signals. The rotation rate is variable and may be closely controlled both as to speed and time of rotation. The bio-disc may also be utilized to write information to the bio-disc either before or after the test material in the flow chamber and target zones is interrogated by the read beam of the drive and analyzed by the analyzer. The bio-disc may include encoded information for controlling the rotation of the disc, providing processing information specific to the type of immunotyping assay to be conducted and for displaying the results on a monitor associated with the bio-drive.

In one embodiment of the present invention, electromagnets are embedded in layers within the optical bio-discs. A bottom electromagnet beneath the detection area on the disc is turned on during deposition and washing of the beads to keep them attached to the bottom surface in the detection area. At this point, some beads will form non-covalent bonds with the bottom surface. Afterward, a top electromagnet over the detection area is turned on while the bottom electromagnet is turned off to remove unattached beads from the bottom surface.

In another embodiment of the present invention, electromagnets are placed outside of the optical bio-disc in a holding apparatus. A bottom electromagnet, placed beneath the optical bio-disc, is turned on during deposition and washing of the beads to keep them attached to the bottom surface of the detection area. Afterward, another electromagnet, placed over the optical bio-disc, is turned on while the bottom electromagnet is turned off to remove unattached beads from the bottom surface.

The present invention is also directed to bio-discs, bio-drives, and related methods. This invention or different aspects thereof may be readily implemented in, adapted to, or employed in combination with the discs, assays, and systems disclosed in the following commonly assigned and co-pending patent applications: U.S. patent application Ser. No. 09/378,878 entitled “Methods and Apparatus for Analyzing Operational and Non-operational Data Acquired from Optical Discs” filed Aug. 23, 1999; U.S. Provisional Patent Application Ser. No. 60/150,288 entitled “Methods and Apparatus for Optical Disc Data Acquisition Using Physical Synchronization Markers” filed Aug. 23, 1999; U.S. patent application Ser. No. 09/421,870 entitled “Trackable Optical Discs with Concurrently Readable Analyte Material” filed Oct. 26, 1999; U.S. patent application Ser. No. 09/643,106 entitled “Methods and Apparatus for Optical Disc Data Acquisition Using Physical Synchronization Markers” filed Aug. 21, 2000; U.S. patent application Ser. No. 09/999,274 entitled “Optical Biodiscs with Reflective Layers” filed Nov. 15, 2001; U.S. patent application Ser. No. 09/988,728 entitled “Methods And Apparatus For Detecting And Quantifying Lymphocytes With Optical Biodiscs” filed Nov. 20, 2001; U.S. patent application Ser. No. 09/988,850 entitled “Methods and Apparatus for Blood Typing with Optical Bio-discs” filed Nov. 19, 2001; U.S. patent application Ser. No. 09/989,684 entitled “Apparatus and Methods for Separating Agglutinants and Disperse Particles” filed Nov. 20, 2001; U.S. patent application Ser. No. 09/997,741 entitled “Dual Bead Assays Including Optical Biodiscs and Methods Relating Thereto” filed Nov. 27, 2001; U.S. patent application Ser. No. 09/997,895 entitled “Apparatus and Methods for Separating Components of Particulate Suspension” filed Nov. 30, 2001; U.S. patent application Ser. No. 10/005,313 entitled “Optical Discs for Measuring Analytes” filed Dec. 7, 2001; U.S. patent application Ser. No. 10/006,371 entitled “Methods for Detecting Analytes Using Optical Discs and Optical Disc Readers” filed Dec. 10, 2001; U.S. patent application Ser. No. 10/006,620 entitled “Multiple Data Layer Optical Discs for Detecting Analytes” filed Dec. 10, 2001; U.S. patent application Ser. No. 10/006,619 entitled “Optical Disc Assemblies for Performing Assays” filed Dec. 10, 2001; U.S. patent application Ser. No. 10/020,140 entitled “Detection System For Disk-Based Laboratory And Improved Optical Bio-Disc Including Same” filed Dec. 14, 2001; U.S. patent application Ser. No. 10/035,836 entitled “Surface Assembly For Immobilizing DNA Capture Probes And Bead-Based Assay Including Optical Bio-Discs And Methods Relating Thereto” filed Dec. 21, 2001; U.S. patent application Ser. No. 10/038,297 entitled “Dual Bead Assays Including Covalent Linkages For Improved Specificity And Related Optical Analysis Discs” filed Jan. 4, 2002; U.S. patent application Ser. No. 10/043,688 entitled “Optical Disc Analysis System Including Related Methods For Biological and Medical Imaging” filed Jan. 10, 2002; and U.S. Provisional Application Ser. No. 60/348,767 entitled “Optical Disc Analysis System Including Related Signal Processing Methods and Software” filed Jan. 14, 2002. All of these applications are herein incorporated by reference in their entireties. They thus provide background and related disclosure as support hereof as if fully repeated herein.

### BRIEF DESCRIPTION OF THE DRAWING

Further objects, aspects, and methods of the present invention together with additional features contributing thereto and advantages accruing therefrom will be apparent from the following description of the preferred embodiments of the invention which are shown in the accompanying, wherein:

FIG. 1 is a pictorial representation of a bio-disc system according to the present invention;

FIG. 2A is a side view of a disc with top and bottom electromagnets in accordance to an embodiment of the present invention;

FIG. 2B is a close-up view of the detection area of the disc with top and bottom electromagnets;

FIG. 2C is a top view of the wire coil that makes up the electromagnet;

FIG. 2D is a pictorial depiction of side view of an apparatus with electromagnet wire coils according to an embodiment of the present invention;

FIG. 3 is a flow chart detailing the operation of using the electromagnet in an assay according to one embodiment of the present invention;

FIG. 4 is a pictorial representation showing assay solution being introduced to detection area;

FIG. 5 is a pictorial representation showing the bottom electromagnet turned on to pull beads to the bottom surface;

FIG. 6 is a pictorial representation showing the bottom electromagnet turned on as the assay solution is washed from the detection area;

FIG. 7 is a pictorial representation showing the top electromagnet turned on and bottom electromagnet turned off to pull up beads unattached to the bottom surface;

FIG. 8 is an exploded perspective view of an example reflective bio-disc with electromagnets;

FIG. 9 is a perspective view of the disc illustrated in FIG. 8 with cut-away sections showing the different layers of the disc;

FIG. 10 is an exploded perspective view of an example transmissive bio-disc with electromagnets;

FIG. 11 is a perspective view of the disc illustrated in FIG. 10 with cut-away sections showing the different layers of the disc;

FIG. 12 is an exploded perspective view of an example reservoir bio-disc with electromagnets;

FIG. 13 is a perspective view of the disc illustrated in FIG. 12 with cut-away sections showing the different layers of the disc; and

FIG. 14 is a perspective and block diagram representation illustrating the operation of the optical bio-disc apparatus in accordance to an embodiment of the present invention.

### DETAILED DESCRIPTION OF THE INVENTION

The present invention is a method and apparatus for precise control of magnetic beads in an optical bio-disc. Embodiments of the present invention use electromagnets for extremely precise control of the forces experienced by the magnetic beads. In the following description, numerous specific details are set forth to provide a more thorough description of embodiments of the invention. It is apparent, however, to one skilled in the art, that the invention may be practiced without these specific details. In other instances, well known features have not been described in detail so as not to obscure the invention.

The present invention is a method and apparatus for precise control of magnetic beads in an optical bio-disc. Embodiments of the present invention use electromagnets for precise control of the forces experienced by the magnetic beads. The use of electromagnets eliminates the need to design precise flow control mechanisms to keep beads in place. The electromagnets can be controlled to exert a very precise amount of force. This is critical in the stage of washing in an assay, where beads attached to a bottom testing surface are separated from beads that are unattached. During this stage, the precision in the amount of force applied to the beads is critical because the difference in force between moving an unattached bead and one that is tethered (i.e. attached) with a few covalent bonds (or biotin/avidin or DNA hybridization) may be extremely slight. Care must be exercised to ensure that unattached beads are the only ones moved and the tethered beads remain attached to an intended surface on the disc. By using electromagnets, the precise control of beads can be accomplished.

A number of embodiments for controlling magnetic beads in an optical bio-disc are described in greater details as follows.

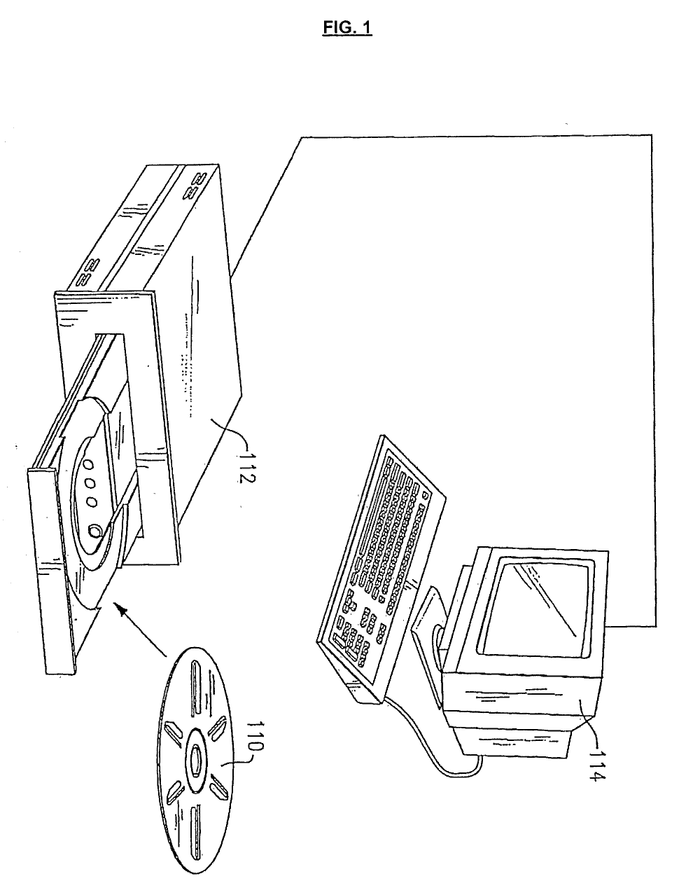

Embodiments of the present invention involve controlling magnetic beads in the course of performing an assay with an optical bio-disc. FIG. 1 is a perspective view of an optical bio-disc 110 according to the present invention. The present optical bio-disc 110 is shown in conjunction with an optical disc drive 112 and a display monitor 114. Test samples are deposited onto designated areas on bio-disc 110. Once the bio-disc is inserted into optical disc drive 112, the disc drive is responsible for collecting information from the sample through the use of electromagnetic radiation beams that have been modified or modulated by interaction with the test samples. After the information is analyzed and processed, computer monitor 114 displays the results.

Electromagnets

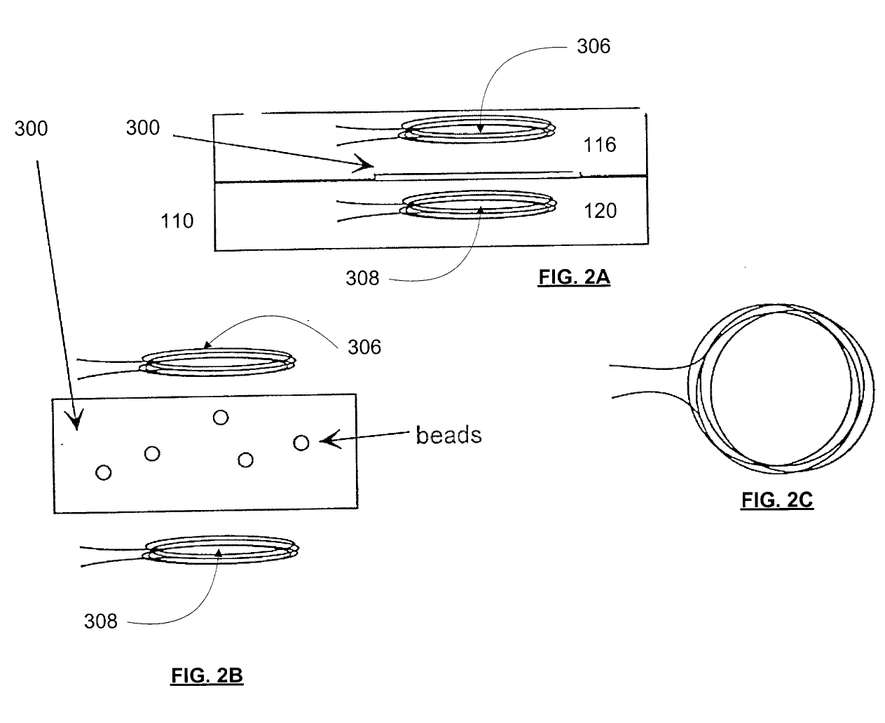

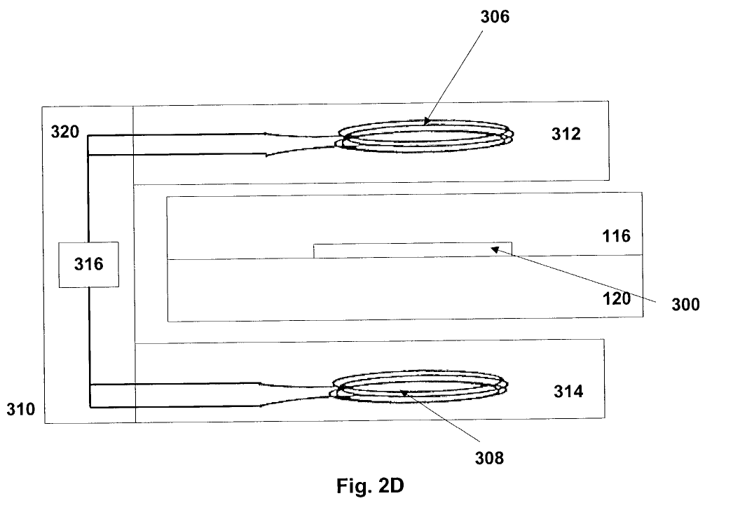

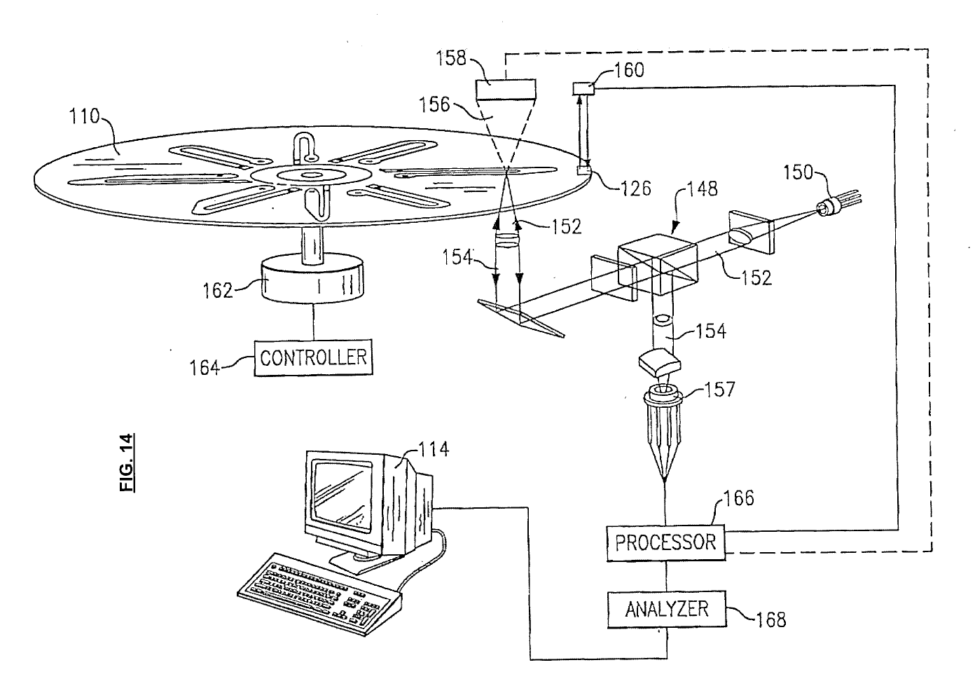

FIGS. 2A, 2B and 2C show the different views of an embodiment of the present invention. FIG. 2A is side view of optical bio-disc 110. Detection area 300 is where magnetic beads are deposited along with assay fluids. It is also where laser beam from the bio-drive interacts with assay solution. Further detail of the laser beam interaction with the assay solution sample is given in conjunction with description of FIG. 14. Detection area 300 is between cap portion 116 and bottom substrate 120 of optical bio-disc 110. Top electromagnet 306 is embedded in cap portion 116 and bottom electromagnet 308 is embedded in bottom substrate 120. Embodiments of the present invention have an on-disc battery with power control to regulate the current flowing through top electromagnet 306 and bottom electromagnet 308. The power control can be externally connected or activated by laser inside the optical bio-drive or by any other common equivalent means in the art.

FIG. 2B offers an accompanying enlarged side view of FIG. 2A. Within the detection area 300 are beads are moved by the top electromagnet 306 and bottom electromagnet 308. FIG. 2C is a top view of an electromagnet wire coil according to an embodiment of the present invention. The coil shape is for illustration only. Any equivalent coil shape capable of generating a magnetic field for controlling beads can be employed.

FIG. 2D shows an alternate embodiment where the electromagnets are placed in outside of an optical bio-disc. In this embodiment, the electromagnets are placed in a holding apparatus outside of the optical bio-disc. The optical bio-disc is placed on top of inside of apparatus 310. Top electromagnet 306 is placed in top arm 312 and bottom electromagnet 308 is placed in bottom arm 314. The two arms are connected by stand 320. They are placed in apparatus 310 where they can effect the movement of the beads in optical bio-disc 110. A battery source with power control 316 is supplied within holding apparatus 310 to control the current flowing through top electromagnet 306 and bottom electromagnet 308.

Operation of the Electromagnets in Assays

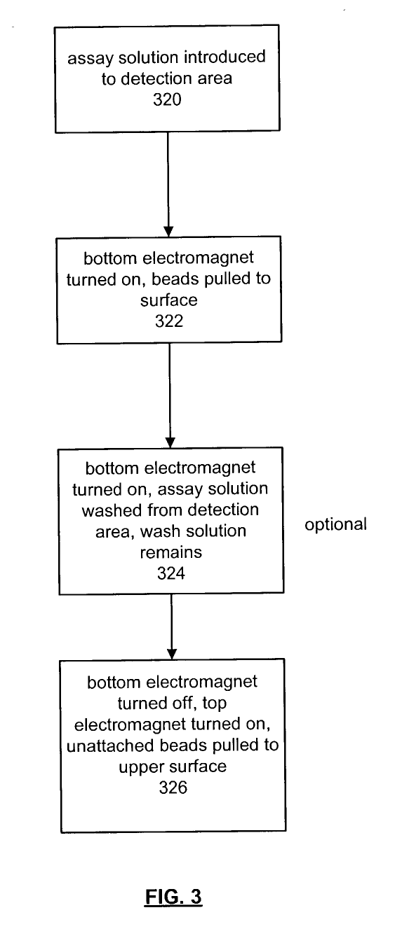

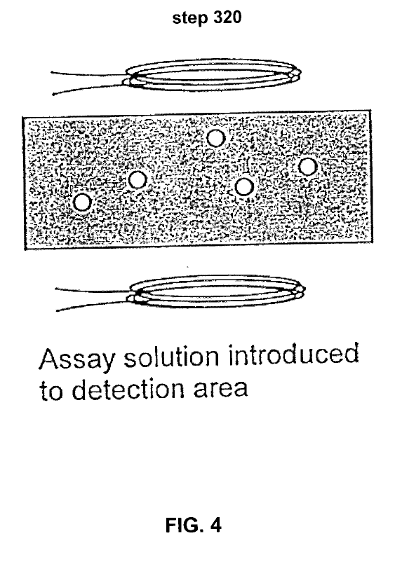

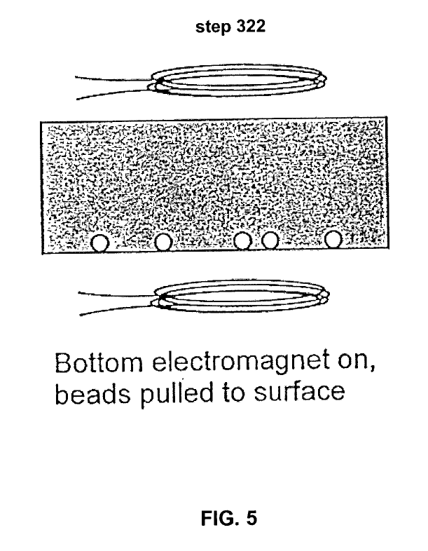

As shown in FIGS. 2A, 2B, 2C and 2D embodiments of the present invention would have an electromagnet beneath and above the detection area, where laser beam from the bio-drive interact with assay solution. The current flow to these electromagnets is controllable via an in-disc battery with power control mechanism. The bottom electromagnet would be activated while the sample solution (containing the beads) was introduced to the detection area. FIG. 3 shows the process of activation of the electromagnets. FIG. 4 shows step 320 of the process. The beads are introduced into the detection area along with the assay solution. FIG. 5 shows step 322 of the process. In this step, the bottom electromagnet is turned on and the beads are pulled to toward the bottom surface of the disc. The beads are pulled down to the disc surface so that their chances of becoming ‘tethered’ (i.e. attached) would be maximized. Some beads will form non-covalent bonds with the disc surface in the detection area.

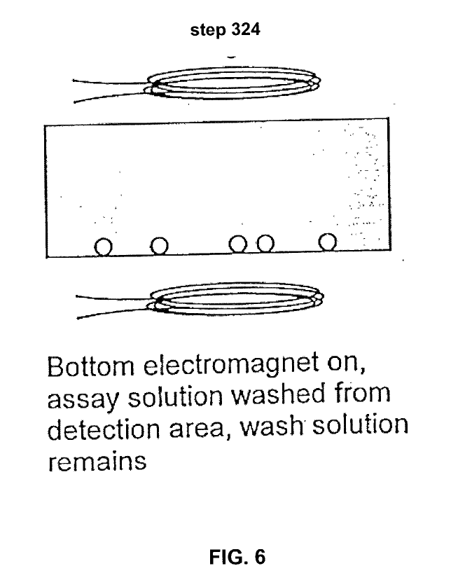

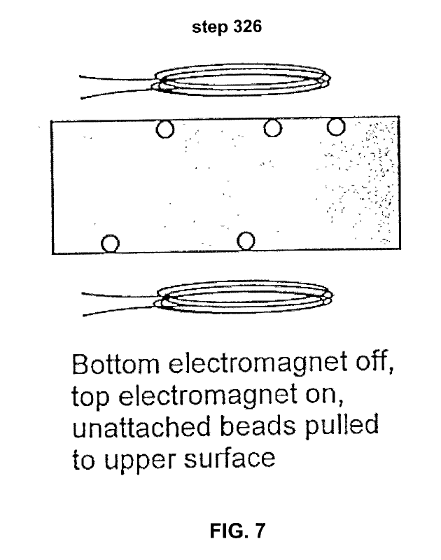

The next step, step 324, which may be optional if the assay solution is transparent enough, is to wash the assay solution from the detection area. This step is depicted in FIG. 6. The wash solution remains in the detection area and needs to be clear so that it doesn't interfere with detection. The bottom electromagnet is turned on during this wash so that precise control of the wash solution flow, which is often difficult, will not be necessary. There is no need to worry about the wash solution applying too much force to the attached beads to tear them away from the bottome surface. In step 326, the bottom electromagnet is then turned off and the top electromagnet is turned on. This step is depicted in FIG. 7. The top electromagnet is calibrated to have a specified force that is just enough to pull the unattached beads upwards, but not enough to pull off the attached beads. The specified force is regulated by the amount of current flowing through the coils in top electromagnet 306. If necessary, the top electromagnet remains on during detection to keep the unattached beads out of the focal plane, which is at the level of the attached beads at the bottom surface of the detection area.

A major concern with the bead assay is the amount of force that a few covalent bonds (or biotin/avidin or DNA hybridization) has to hold a bead to the disc surface. Since the assay area has a liquid depth of 20-50 microns, the amount of capillary force that is required to move liquids through this area is quite high. In order to keep liquid flow at a low enough level so that attached beads are not stripped off, you need to have precise control of the forces moving the liquids.

It is possible that centrifugal force can be controlled precisely and, with the use of capillary valves, the flow can be controlled. By carefully controlling the taper of the capillary valve, enough control could be maintained. However, such flow control mechanism is difficult to design and implement correctly. With the present invention, electromagnets can hold the beads in place without extensive effort in designing and implementing capillary valves and flow control mechanisms.

Optical Bio-Disc Embodiments

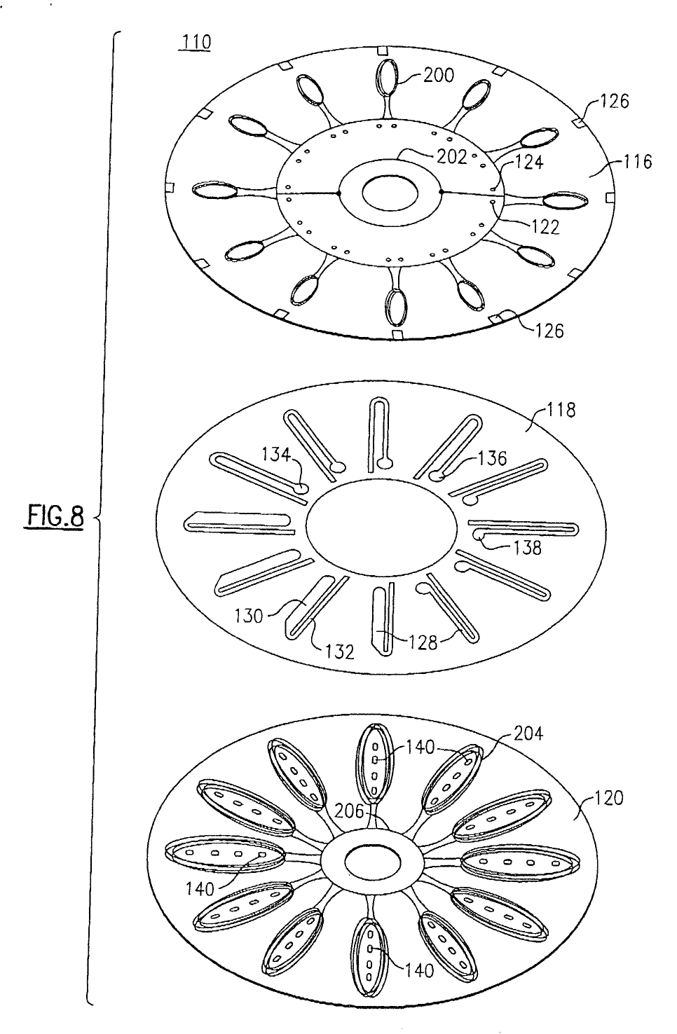

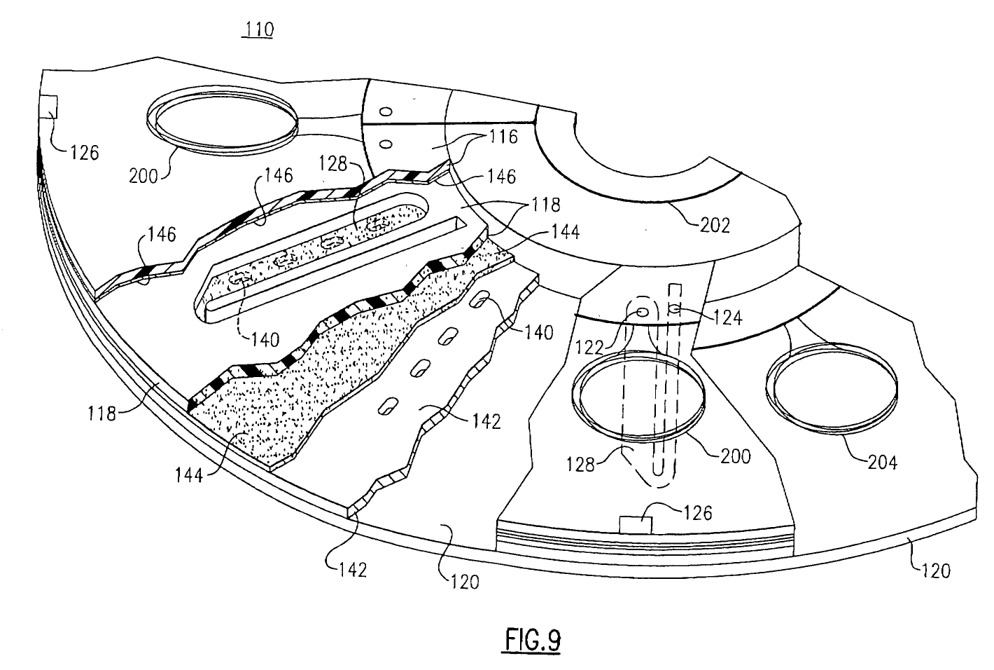

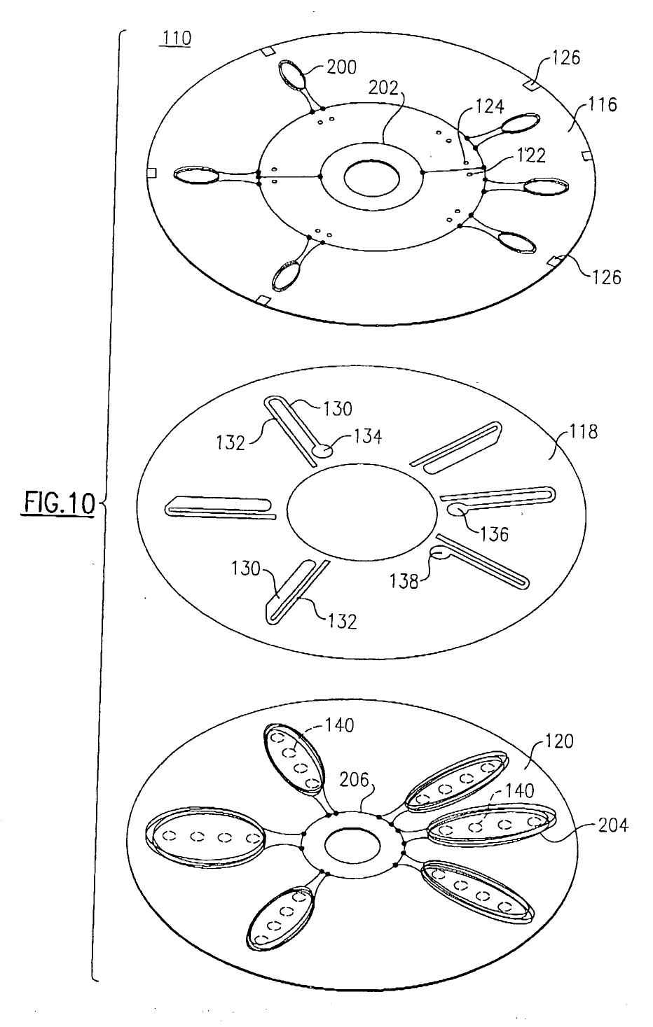

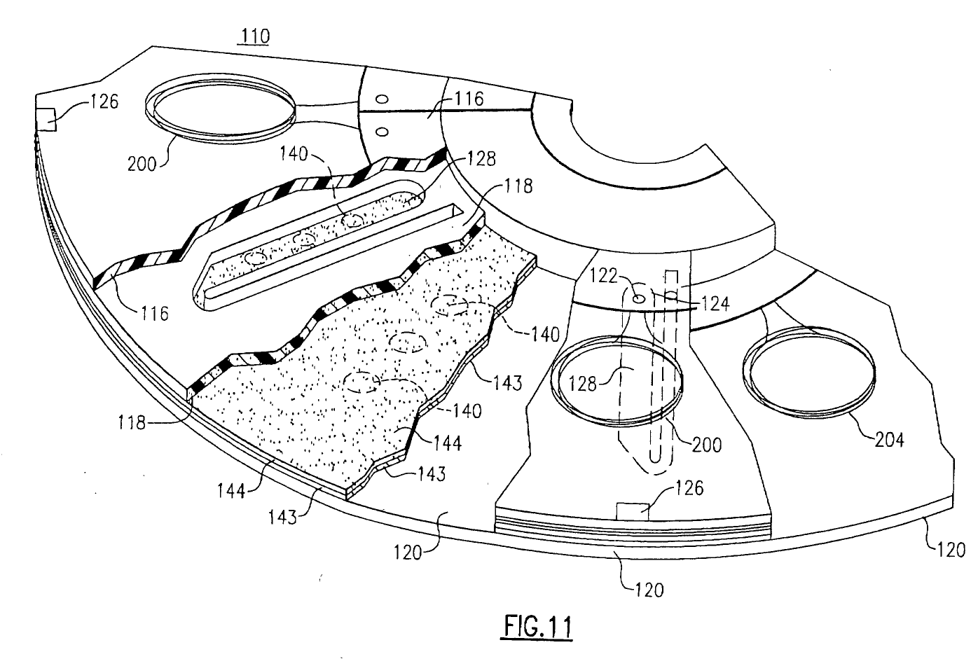

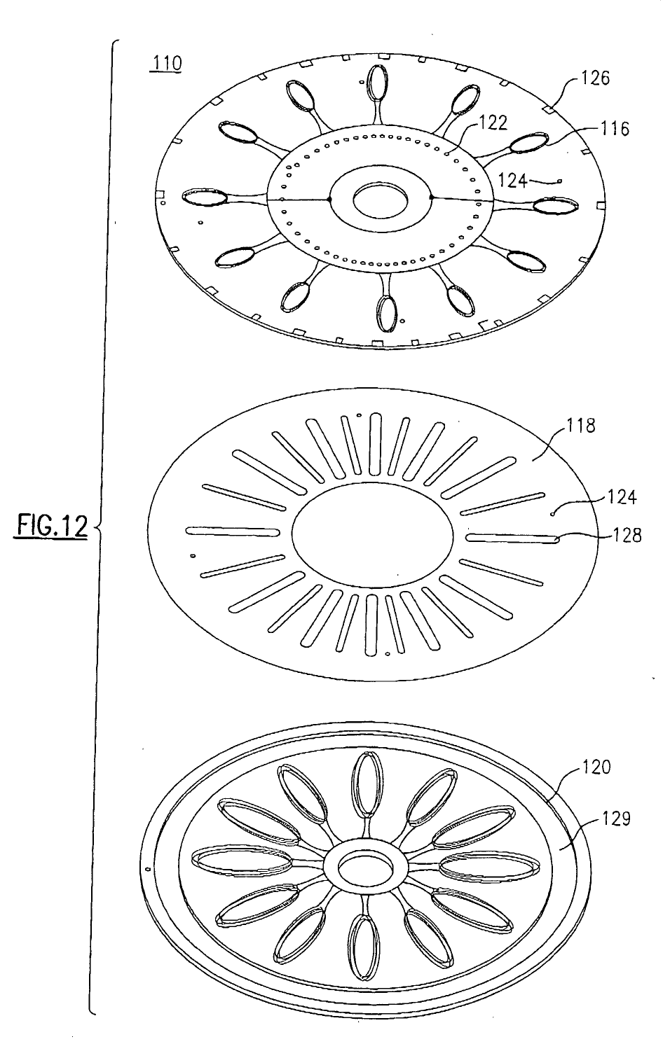

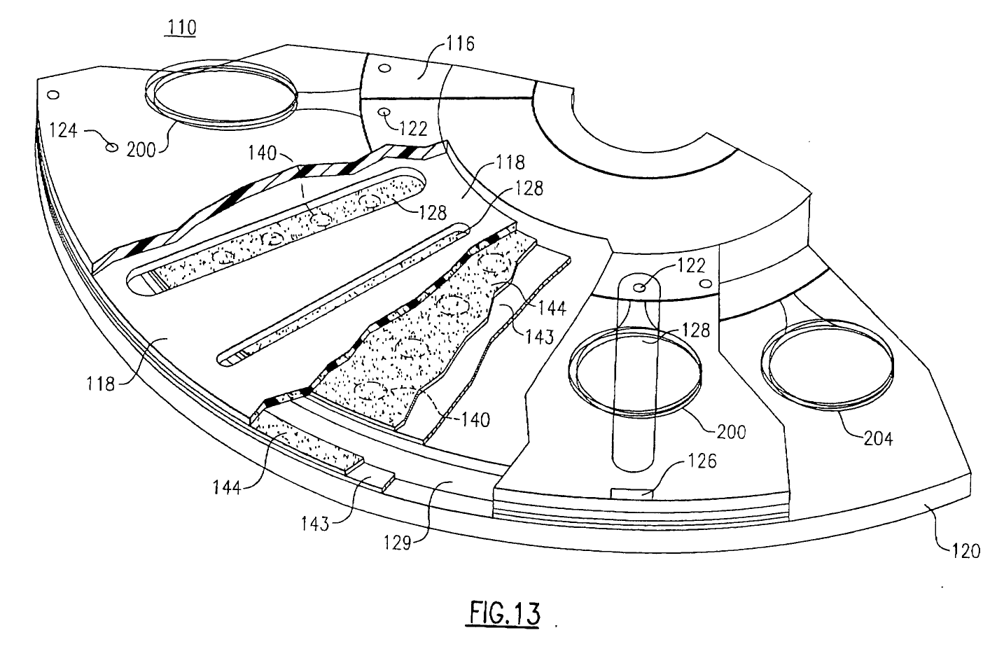

FIG. 8 through FIG. 13 offers three example embodiments of placing electromagnets within optical bio-discs for magnetic bead control. FIGS. 8 and 9 depict a reflective embodiment of an optical bio-disc. FIGS. 10 and 11 depict a transmissive embodiment of an optical bio-disc. FIGS. 12 and 13 depict a reservoir type embodiment of an optical bio-disc. It should be understood that these example embodiments offer illustration of how electromagnets can be placed on optical bio-discs and the present invention can be applied to many equivalent configurations of optical bio-discs.

FIG. 8 is an exploded perspective view of the structural elements of one embodiment of the optical bio-disc 110. FIG. 8 is an example of a reflective type optical bio-disc 110 that may be used in the present invention. The structural elements include a cap portion 116, an adhesive member 118, and a substrate 120.

The cap portion 116 includes one or more inlet ports 122 and one or more vent ports 124. The cap portion 116 may be formed from polycarbonate. Electromagnets 200 are placed within cap portion 116, one per fluidic channel 128. They are connected by a battery source 202 with power control mechanism for turning electromagnets off and on and adjusting the current flow. The power control, can be for example, externally connected or activated by laser inside the optical bio-drive or by any other common equivalent means in the art. In one embodiment, the electromagnets are coils as shown in FIG. 8, but they can be of any form and configuration as needed.

In a preferred embodiment, trigger markings 126 are included on the surface of the reflective layer 142. Trigger markings 126 may include a clear window in all three layers of the bio-disc, an opaque area, or a reflective or semi-reflective area encoded with information.

The second element shown in FIG. 8 is an adhesive member 118 having fluidic circuits 128 or U-channels formed therein. The fluidic circuits 128 are formed by stamping or cutting the membrane to remove plastic film and form the shapes as indicated. Each of the fluidic circuits 128 includes a flow channel 130 and a return channel 132. Some of the fluidic circuits 128 illustrated in FIG. 8 include a mixing chamber 134. Two different types of mixing chambers 134 are illustrated. The first is a symmetric mixing chamber 136 that is symmetrically formed relative to the flow channel 130. The second is an off-set mixing chamber 138. The off-set mixing chamber 138 is formed to one side of the flow channel 130 as indicated.

The third element illustrated in FIG. 8 is a substrate 120 including target or capture zones 140. The substrate 120 is preferably made of polycarbonate. Electromagnets 204 are placed within substrate 120, one per fluidic channel 128. They are connected by a battery source 206 with power control mechanism for turning electromagnets off and on and adjusting the current flow. The power control, can be for example, externally connected or activated by laser inside the optical bio-drive or by any other common equivalent means in the art. In one embodiment, the electromagnets are coils as shown in FIG. 8, but they can be of any form and configuration as needed.

The target zones 140 are formed by removing the reflective layer 142 in the indicated shape or alternatively in any desired shape. Alternatively, the target zone 140 may be formed by a masking technique that includes masking the target zone 140 area before applying the reflective layer 142. The reflective layer 142 may be formed from a metal such as aluminum or gold.

FIG. 9 is an enlarged perspective view of the reflective zone type optical bio-disc 110 according to one embodiment of the present invention. This view includes a portion of the various layers thereof, cut away to illustrate a partial sectional view of each layer, substrate, coating, or membrane. FIG. 9 shows the substrate 120 that is coated with the reflective layer 142. Bottom electromagnets 204 are placed in this layer. An active layer 144 is applied over the reflective layer 142. In the preferred embodiment, the active layer 144 may be formed from polystyrene. Alternatively, polycarbonate, gold, activated glass, modified glass, or modified polystyrene, for example, polystyrene-co-maleic anhydride, may be used. In addition hydrogels can be used. Alternatively other as illustrated in this embodiment, the plastic adhesive member 118 is applied over the active layer 144. The exposed section of the plastic adhesive member 118 illustrates the cut out or stamped U-shaped form that creates the fluidic circuits 128. The final structural layer in this reflective zone embodiment of the present bio-disc is the cap portion 116. Top electromagnets 200 are placed in this layer. The cap portion 116 includes the reflective surface 146 on the bottom thereof. The reflective surface 146 may be made from a metal such as aluminum or gold.

FIG. 10 is an exploded perspective view of the structural elements of a transmissive type of optical bio-disc 110 according to the present invention. The structural elements of the transmissive type of optical bio-disc 110 similarly include the cap portion 116, the adhesive member 118, and the substrate 120 layer.

The cap portion 116 includes one or more inlet ports 122 and one or more vent ports 124. The cap portion 116 may be formed from a polycarbonate layer. Electromagnets 200 are placed within cap portion 116, one per fluidic channel 128. They are connected by a battery source 202 with power control mechanism for turning electromagnets off and on and adjusting the current flow. The power control, can be for example, externally connected or activated by laser inside the optical bio-drive or by any other common equivalent means in the art. In one embodiment, the electromagnets are coils as shown in FIG. 10, but they can be of any form and configuration as needed.

Optional trigger markings 126 may be included on the surface of a thin semi-reflective layer 143, as best illustrated in FIG. 11. Trigger markings 126 may include a clear window in all three layers of the bio-disc, an opaque area, or a reflective or semi-reflective area encoded with information.

The second element shown in FIG. 10 is the adhesive member 118 having fluidic circuits 128 or U-channels formed therein. The fluidic circuits 128 are formed by stamping or cutting the membrane to remove plastic film and form the shapes as indicated. Each of the fluidic circuits 128 includes the flow channel 130 and the return channel 132. Some of the fluidic circuits 128 illustrated in FIG. 10 include the mixing chamber 134. Two different types of mixing chambers 134 are illustrated. The first is the symmetric mixing chamber 136 that is symmetrically formed relative to the flow channel 130. The second is the off-set mixing chamber 138. The off-set mixing chamber 138 is formed to one side of the flow channel 130 as indicated.

The third element illustrated in FIG. 10 is the substrate 120, which may include the target or capture zones 140. The target or capture zones 140 are where the electromagnetic beams will interact with the test samples. After the spinning of the disc, specific components of cells in the samples are captured in different capture zones by the various antigens inside the chamber. The substrate 120 is preferably made of polycarbonate and has the thin semi-reflective layer 143 deposited on the top thereof, as shown in FIG. 11. Electromagnets 204 are placed within substrate 120, one per fluidic channel 128. They are connected by a battery source 206 with power control mechanism for turning electromagnets off and on and adjusting the current flow. The power control, can be for example, externally connected or activated by laser inside the optical bio-drive or by any other common equivalent means in the art. In one embodiment, the electromagnets are coils as shown in FIG. 10, but they can be of any form and configuration as needed.

The semi-reflective layer 143 associated with the substrate 120 of the transmissive disc 110 illustrated in FIGS. 10 and 11 is significantly thinner than the reflective layer 142 on the substrate 120 of the reflective disc 110 illustrated in FIGS. 8 and 9. The thinner semi-reflective layer 143 allows for some transmission of the interrogation beam 152 through the structural layers of the transmissive disc. The thin semi-reflective layer 143 may be formed from a metal such as aluminum or gold.

FIG. 11 is an enlarged perspective view of the optical bio-disc 110 according to the transmissive disc embodiment of the present invention. The disc 110 is illustrated with a portion of the various layers thereof cut away to illustrate a partial sectional view of each layer, substrate, coating, or membrane. FIG. 11 illustrates a transmissive disc format with the clear cap portion 116, the thin semi-reflective layer 143 on the substrate 120, and trigger markings 126. FIG. 11 also shows, the target zones 140 formed by marking the designated area in the indicated shape or alternatively in any desired shape. Markings to indicate target zone 140 may be made on the thin semi-reflective layer 143 on the substrate 120 or on the bottom portion of the substrate 120 (under the disc). Bottom electromagnets 204 are placed in substrate layer 120

Alternatively, the target zones 140 may be formed by a masking technique that includes masking the entire thin semi-reflective layer 143 except the target zones 140. In this embodiment, target zones 140 may be created by silk screening ink onto the thin semi-reflective layer 143. An active layer 144 is applied over the thin semi-reflective layer 143. In the preferred embodiment, the active layer 144 is a 40 to 200 μm thick layer of 2% polystyrene. Alternatively, polycarbonate, gold, activated glass, modified glass, or modified polystyrene, for example, polystyrene-co-maleic anhydride, may be used. In addition hydrogels can be used. As illustrated in this embodiment, the plastic adhesive member 118 is applied over the active layer 144. The exposed section of the plastic adhesive member 118 illustrates the cut out or stamped U-shaped form that creates the fluidic circuits 128. The final structural layer in this transmissive embodiment of the present bio-disc 110 is the clear, non-reflective cap portion 116 that includes inlet ports 122 and vent ports 124 and top electromagnets 200.

FIG. 12 is an exploded perspective view of the principal structural elements of yet another embodiment of the optical bio-disc 110 of the present invention. This embodiment is generally referred to herein as a “reservoir optical bio-disc”. This embodiment may be implemented in either the reflective or transmissive formats optical bio-discussed above. In the alternative, the optical bio-disc according to the invention may be implement as a hybrid optical bio-disc that has both transmissive and reflective formats and further any desired combination of fluidic channels and circumferencial reservoirs.

The principal structural elements of this reservoir embodiment similarly include a cap portion 116, an adhesive member or channel layer 118, and a substrate 120. The cap portion 116 includes one or more inlet ports 122 and one or more vent ports 124. The vent ports 124 allows venting of air in the fluidic channels or fluidic circuits of the optical bio-disc thereby preventing air blocks within the fluidic circuits when the optical bio-disc is in use. The cap portion 116 is preferably formed from polycarbonate and may be either left clear or coated with a reflective surface 146 when implemented in the reflective format. Electromagnets 200 are placed within cap portion 116, one per fluidic channel 128. They are connected by a battery source 202 with power control mechanism for turning electromagnets off and on and adjusting the current flow. The power control, can be for example, externally connected or activated by laser inside the optical bio-drive or by any other common equivalent means in the art. In one embodiment, the electromagnets are coils as shown in FIG. 12, but they can be of any form and configuration as needed.

In the preferred embodiment reflective reservoir optical bio-disc, trigger markings 126 are included on the surface of the reflective layer 142. According to one aspect of the present invention, trigger markings 126 are as wide as the respective fluidic circuits 128.

The second element shown in FIG. 12 is the adhesive member or channel layer 118 having fluidic circuits or straight channels 128 formed therein. According to one embodiment of the present invention, these fluidic circuits 128 are directed along the radii of the optical bio-disc as illustrated. The fluidic circuits 128 are formed by stamping or cutting the membrane to remove the plastic film and form the shapes as indicated.

The third element illustrated in FIG. 12 is the substrate 120. The substrate 120 is preferably made of polycarbonate and has either the reflective metal layer 142 or the thin semi-reflective metal layer 143 deposited on the top thereof depending on whether the reflective or transmissive format is desired. As indicated above, layers 142 or 143 may be formed from a metal such as aluminum, gold, silver, nickel, and reflective metal alloys. The substrate 120 is provided with a reservoir 129 along the outer edge that is preferably implemented as the peripheral-circumferential reservoir 129 as illustrated. Electromagnets 204 are placed within substrate 120, one per fluidic channel 128. They are connected by a battery source 206 with power control mechanism for turning electromagnets off and on and adjusting the current flow. The power control, can be for example, externally connected or activated by laser inside the optical bio-drive or by any other common equivalent means in the art. In one embodiment, the electromagnets are coils as shown in FIG. 12, but they can be of any form and configuration as needed.

FIG. 13 presents an enlarged perspective view of the optical bio-disc 110 according to the reservoir optical bio-disc embodiment of the present invention shown in FIG. 12. The optical bio-disc 110 is illustrated with a portion of the various layers thereof cut away to illustrate a partial sectional view of each principal layer, substrate, coating, or membrane. FIG. 13 illustrates a reservoir optical bio-disc in the transmissive format with the clear cap portion 116, the thin semi-reflective layer 143 on the substrate 120, and trigger markings 126. Trigger markings 126 include opaque material placed on the top portion of the cap.

FIG. 13 also shows an active layer 144 that may be applied over the thin semi-reflective layer 143. In the preferred embodiment, the active layer 144 is a 40 to 200 μm thick layer of 2% polystyrene. Alternatively, polycarbonate, gold, activated glass, modified glass, or modified polystyrene, for example, polystyrene-co-maleic anhydride, may be used. The active layer 144 may also be preferably formed through derivatization of the reflective layer 142 with self assembling monolayers such as, for example, dative binding of functionally active mercapto compounds on gold and binding of functionalized silicone compounds on aluminum. In addition hydrogels can also be used. As illustrated in this embodiment, the plastic adhesive member 118 is applied over the active layer 144. If the active layer 144 is not present, the adhesive member 118 is directly applied over the semi-reflective metal layer 143. The exposed section of the plastic adhesive member 118 illustrates the cut out or stamped straight shaped form that creates the fluidic circuits 128. The exposed section of the substrate 120 illustrates the peripheral circumferential reservoir 129. Bottom electromagnets 204 are placed in substrate layer 120. The final principal structural layer in this embodiment of the present optical bio-disc 110 is the clear, non-reflective cap portion 116 that includes inlet ports 122 and vent ports 124. Top electromagnets 200 are placed in this layer.

Optical Bio-disc Apparatus

FIG. 14 is a representation in perspective and block diagram illustrating the operation of optical component 148, a light source 150 that produces the incident or interrogation beam 152, a return beam 154, and a transmitted beam 156. In the case of the reflective bio-disc embodiment, the return beam 154 is reflected from the reflective surface 146 of the cap portion 116 of the optical bio-disc 110. In this reflective embodiment of the present optical bio-disc 110, the return beam 154 is detected and analyzed for the presence of signal agents by a bottom detector 157. In the transmissive bio-disc embodiment, the transmitted beam 156 is detected by a top detector 158 and is also analyzed for the presence of signal agents. In the transmissive embodiment, a photo detector may be used as a top detector 158.

FIG. 14 also shows a hardware trigger mechanism that includes the trigger markings 126 on the disc and a trigger detector 160. The hardware triggering mechanism is used in both reflective bio-discs and transmissive bio-discs. The triggering mechanism allows the processor 166 to collect data only when the interrogation beam 152 is on a respective target or capture zone 140. Furthermore, in the transmissive bio-disc system, a software trigger may also be used. The software trigger uses the bottom detector to signal the processor 166 to collect data as soon as the interrogation beam 152 hits the edge of a respective target or capture zone 140. FIG. 10A also illustrates a drive motor 162 and a controller 164 for controlling the rotation of the optical bio-disc 110. FIG. 10A further shows the processor 166 and analyzer 168 implemented in the alternative for processing the return beam 154 and transmitted beam 156 associated the transmissive optical bio-disc. In the case of the transmissive optical bio-disc, the transmitted beam 156 carries the information about the biological sample. In this embodiment, there is pre-recorded information on disc. Detector 158 collects the beam.

Conclusion

Thus a method and apparatus for controlling magnetic beads in optical bio-disc is described in conjunction with one or more specific embodiments. While this invention has been described in detail with reference to certain preferred embodiments, it should be appreciated that the present invention is not limited to those precise embodiments. Rather, in view of the present disclosure, which describes the current best mode for practicing the invention, many modifications and variations would present themselves to those of skill in the art without departing from the scope and spirit of this invention. The invention is defined by the claims and their full scope of equivalents.

We claim:

1. A method of controlling magnetic beads, said method comprising the steps of:
obtaining an optical disc with at least one detection area;
embedding a top electromagnet in a cap layer of said disc over said detection area; and
embedding a bottom electromagnet in a bottom substrate of said disc under said detection area.

2. The method of claim 1 further comprising the steps of:
placing assay solution into said detection area;
placing magnetic beads into said detection area;
turning on said bottom electromagnet to pull said magnetic beads to the bottom surface of said detection area;
allowing a plurality of said magnetic beads to attach to said bottom surface;
turning off said bottom electromagnet;
turning on said top electromagnet to a specified power whereby unattached beads are pulled to the top surface of said detection area and attached beads remain attached to said bottom surface of said detection area.

3. The method of claim 2 wherein said specified power is less than the non-covalent bonds between said bottom surface and said attached beads.

4. The method of claim 2 wherein said step of allowing further comprises the step of washing said assay solution from said detection area with a wash solution.

5. The method of claim 1 wherein said top electromagnet is attached to a battery source with power control.

6. The method of claim 1 wherein said bottom electromagnet is attached to a battery source with power control.

7. The method of claim 1 wherein said top electromagnet is embedded in a top arm in a holding apparatus over said detection area said optical disc.

8. The method of claim 7 wherein said top electromagnet is attached to a battery source with power control.

9. The method of claim 1 wherein said bottom electromagnet is embedded in a bottom arm in a holding apparatus under said detection area said optical disc.

10. The method of claim 9 wherein said bottom electromagnet is attached to a battery source with power control.

11. An optical bio-disc for performing assays, comprising;
a cap layer;
a middle layer comprising at least one fluidic channel;
a bottom substrate;
a top electromagnet embedded in said cap layer positioned over said fluidic channel; and
a bottom electromagnet embedded in said bottom substrate positioned over said fluidic channel.

12. The optical bio-disc of claim 11 wherein said top electromagnet is attached to a battery source with power control embedded in said cap layer.

13. The optical bio-disc of claim 11 wherein said bottom electromagnet is attached to a battery source with power control embedded in said bottom substrate.

14. A holding apparatus comprising;
a top arm;
a bottom arm;
a stand connecting said top and bottom arms;
a top electromagnet embedded in said top arm;
a bottom electromagnet embedded in said bottom arm;
a surface on said bottom arm facing said top arm whereby an optical bio-disc with assay solution and magnetic beads is placed; and
a battery source with power control for directing current into said top and bottom electromagnets for controlling the movement of said magnetic beads.
